(19) United States
(12) Patent Application Publication
(10) Pub. No.: US 2026/0110791 A1
(43) Pub. Date: Apr. 23, 2026

(54) Methods in Radar Receiver and Transmitter for Detecting Objects of Interest

(71) Applicant: Telefonaktiebolaget LM Ericsson (publ), Stockholm (SE)

(72) Inventors: Robert Baldemair, Solna (SE); Håkan Björkegren, Täby (SE)

(21) Appl. No.: 19/117,991

(22) PCT Filed: Oct. 5, 2023
(86) PCT No.: PCT/SE2023/050997

§ 371 Date: Apr. 3, 2025

Related U.S. Application Data
(60) Provisional application No. 63/413,311, filed on Oct. 5, 2022.

(51) Int. Cl. G01S 13/58; G01S 7/288; G01S 7/292; G01S 7/41

(52) U.S. Cl. CPC G01S 13/582; G01S 7/2883; G01S 7/2886; G01S 7/2923; G01S 7/415; G01S 7/418

(57) ABSTRACT

Embodiments include methods for a radar receiver, including receiving a composite signal corresponding to a transmitted radar signal. The composite signal comprises a plurality (M) of signal streams corresponding to a respective plurality (M) of signal pulses in the transmitted radar signal. Each signal pulse includes a main pulse and a cyclic extension (CE). Each signal stream includes delayed samples corresponding to a plurality of propagation delays of the corresponding signal pulse. Such methods include performing a cyclic correlation of each signal stream with a replica of the main pulse of the corresponding signal pulse, thereby generating a delay-time plane comprising a plurality (M) of correlation streams including samples corresponding to the plurality of propagation delays. Such methods include performing a plurality of DFTs on the correlation streams to generate a delay-Doppler plane. Such methods include searching the delay-Doppler plane for magnitude peaks corresponding to detected objects.

### TECHNICAL FIELD

The present disclosure relates generally to detection of objects using radar, and more specifically to techniques for detecting objects of interest (e.g., moving objects) that are proximate to objects that are not of interest (“clutter”).

### BACKGROUND

Radar is a detection system that uses radio waves to determine the distance, angle, and/or radial velocity of objects relative to a transmitter of the radio waves. Radar can be used to detect various stationary and moving objects such as aircraft, ships, spacecraft, missiles, cars and other motor vehicles, weather formations, and terrain. A radar system in general consists of a transmitter that generates the radar signal, one or more transmitting antennas, one or more receiving antennas (which may or may not be the transmitting antennas), and a receiver that processes the signals from the receiving antennas to detect and/or determine properties of objects. In particular, the transmitted radio waves reflect off objects in their paths and return to the receiver, which can detect properties of the objects based on transmit-receive round-trip delay and other characteristics of the received signals.

FIG. 1 illustrates an exemplary transmitted radar signal comprising a series of M pulses, indexed 0 to M-1. In the time domain, the M pulses are generally uniform in shape and are spaced apart by a period T (e.g., between the starts of successive pulses). The signal shown in FIG. 1, reflects from an object (target), with the reflected signal (“echo”) being received by a radar receiver that may be (but is not necessarily) co-located with the transmitter. The pulsed arrangement of the signal in FIG. 1 facilitates detection of range to the target and target velocity.

In monostatic radar, the transmitter and receiver are collocated and the delay between a transmitted pulse and the received echo (referred to as “round trip time” or RTT) determines range to the target. The frequency bandwidth of each pulse determines the resolution of the range determination. A moving object introduces a Doppler shift in the echo, which manifests itself as a phase change between successive received pulses. The amount of phase change can be used to determine target velocity. The pulse period T establishes the maximum velocity that can be detected without ambiguity, and the number of pulses (M) establishes the resolution of the velocity determination.

FIG. 2 illustrates exemplary processing of echoes of the radar signal shown in FIG. 1 by a radar receiver. The receiver correlates each received (echo) pulse with a copy of the transmitted pulse over a range of delays using a time-domain matched filter. As shown in FIG. 2, the receiver uses M matched filters corresponding to the M pulses. The 2D-representation of the signals after matched filtering is referred to as “delay-time plane”. The receiver then applies multiple fast Fourier transforms (FFTs) to the matched filter outputs, specifically each FFT across M samples from the matched filter outputs corresponding to a single delay value or hypothesis. In other words, each FFT corresponds to a different delay. The 2D representation of the FFT outputs is referred to as “delay-Doppler plane”.

A magnitude peak in the delay-Doppler plane corresponds to a detected object, with the delay and Doppler coordinates of the peak corresponding to the detected object's distance and velocity, respectively. For example, echoes from a moving object will generate a peak at some non-zero Doppler while echoes from a stationary object will generate a peak at zero Doppler. In the example shown in FIG. 2, three objects are identified in the delay-Doppler plane, i.e., one stationary and two moving (or non-stationary).

### SUMMARY

The strength of an echo (i.e., how much impinging energy is reflected) from an object is determined by the object's radar cross section (RCS). Stationary objects such as buildings, parked vehicles, etc. often have large RCS due to size and/or material properties, such as amount of metal content. In some scenarios, however, the objective is to detect certain moving objects such as pedestrians, bicycles, etc. while the surrounding stationary objects are not of interest (“clutter”). This is made more difficult by the moving objects of interest having much lower RCS than the surrounding stationary objects. This can lead to misdetections of moving objects that are present, which can have disastrous consequences in radar-based applications such as autonomous driving.

An object of embodiments of the present disclosure is to improve radar-based detection of objects (e.g., moving objects), such as by providing, enabling, and/or facilitating solutions to overcome exemplary problems summarized above and described in more detail below.

Some embodiments include methods (e.g., procedures) for a radar receiver.

These exemplary methods include receiving a composite signal corresponding to a transmitted radar signal. The composite signal comprises a plurality (M) of signal streams corresponding to a respective plurality (M) of signal pulses in the transmitted radar signal. Each signal pulse in the transmitted signal includes a main pulse and a cyclic extension (CE). Each signal stream includes delayed samples corresponding to a plurality of propagation delays of the corresponding signal pulse.

These exemplary methods also include performing a cyclic correlation of each signal stream with a replica of the main pulse of the corresponding signal pulse, thereby generating a delay-time plane comprising a plurality (M) of correlation streams including samples corresponding to the plurality of propagation delays. These exemplary methods also include performing a plurality of discrete Fourier transforms (DFTs, e.g., FFTs) on the correlation streams to generate a delay-Doppler plane. The respective DFTs are performed on samples from all correlation streams corresponding to respective propagation delays. These exemplary methods also include searching the delay-Doppler plane for magnitude peaks corresponding to detected objects.

In some embodiments, based on the searching, one or more objects are detected in the delay-Doppler plane, e.g., at non-zero Doppler values. In some embodiments, the CEs of the plurality (M) of signal pulses have a common length, with the common length being sufficient to capture echoes from objects at a maximum detection range. In some embodiments, the main pulses of the plurality (M) of signal pulses have a common periodic ACF, which includes a single non-zero value. In some embodiments, each main pulse of the plurality (M) of signal pulses is based on an input sequence (X) whose values have a constant modulus or magnitude. In some of these embodiments, each input sequence (X), on which one or more of the main pulses are based, is one of the following: quadrature phase shift keying (QPSK) sequence, binary phase shift keying (BPSK) sequence, or Zadoff-Chu sequence.

In some embodiments, the radar receiver can or may apply a first window function configured to improve localization of objects in a delay dimension of the delay-Doppler plane and/or a second window function configured to improve localization of objects in a Doppler dimension of the delay-Doppler plane. In some of these embodiments, the first window function is configured to be complementary to a third window function configured to be applied to each main pulse of the plurality (M) of signal pulses included in the transmitted radar signal. In some of these embodiments, the second window function is configured to be complementary to a fourth window function configured to be applied to the main pulses of the plurality (M) of signal pulses included in the transmitted radar signal.

Other embodiments include methods (e.g., procedures) for a radar transmitter. In general, these methods are complementary to the methods for a radar receiver summarized above.

These exemplary methods include generating a plurality (M) of signal pulses. Each signal pulse includes a main pulse and a cyclic extension (CE). These exemplary methods also include transmitting the plurality (M) of signal pulses in a radar signal. In various embodiments, the signal pulses and their constituent main pulses and CEs can or may have any of the properties summarized above in relation to radar receiver embodiments.

In some embodiments, the radar transmitter can or may apply a first window function configured to improve localization of objects by radar receivers in a delay dimension of a delay-Doppler plane, and/or a second window function configured to improve localization of objects by radar receivers in a Doppler dimension of the delay-Doppler plane. In some of these embodiments, the first window function is configured to be complementary to a third window function configured to be applied to echoes of the transmitted radar signal that are received by radar receivers. In some of these embodiments, the second window function is configured to be complementary to a fourth window function configured to be applied to echoes of the transmitted radar signal that are received by radar receivers.

Other embodiments include radar receivers, radar transmitters, and/or radar transceivers configured to perform operations corresponding to any of the exemplary methods described herein. Other embodiments include non-transitory, computer-readable media storing program instructions that, when executed by processing circuitry, configure such radar receivers, radar transmitters, and/or radar transceivers to perform operations corresponding to any of the exemplary methods described herein.

These and other embodiments described herein may be used to improve suppression of clutter from stationary objects in the processing of echo signals by radar receivers, thereby improving the detection of non-stationary objects of interest that may be proximate to the stationary objects within the aperture of transmitted radar signal. In this manner, embodiments can or may improve the operation of radar in applications such as autonomous driving.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 illustrates an exemplary transmitted radar signal comprising a series of M pulses.

FIG. 2 illustrates exemplary processing of echoes of the radar signal shown in FIG. 1 by a radar receiver.

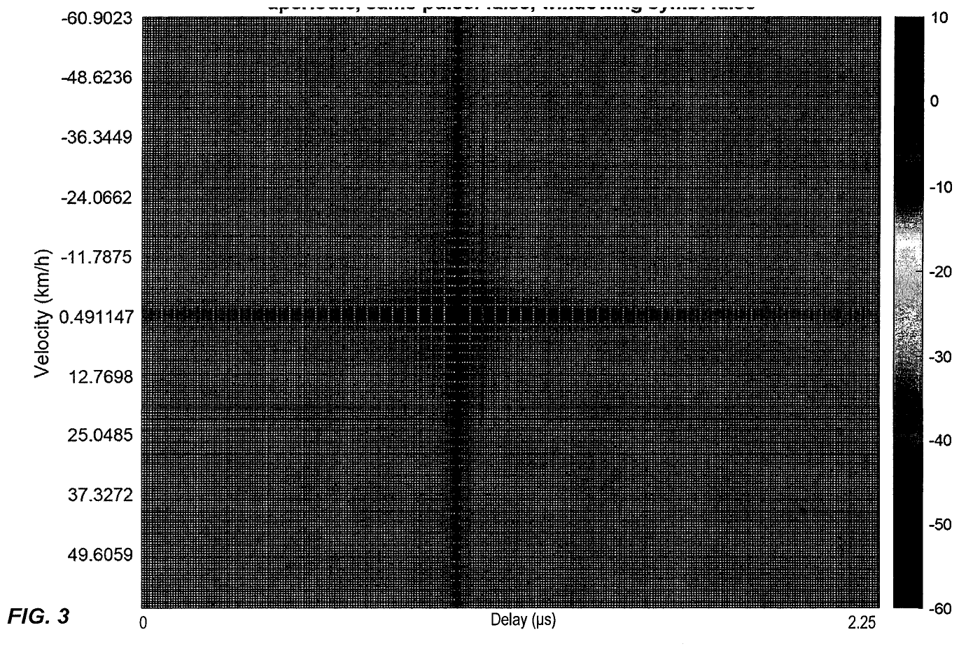

FIGS. 3-4 show different views of a delay-Doppler plane for a stationary object with a range corresponding to 1-μs RTT, based on a conventional transmitted radar signal.

FIG. 5 illustrates an exemplary transmitted radar signal comprising a series of M pulses with cyclic extensions (CE), according to various embodiments of the present disclosure.

FIG. 6 illustrates exemplary processing of echoes of the radar signal shown in FIG. 5 by a radar receiver.

FIG. 7 illustrates operation of an exemplary cyclic correlator, according to various embodiments of the present disclosure.

FIG. 8 shows exemplary arrangements for windowing by a radar receiver, according to various embodiments of the present disclosure.

FIG. 9 shows exemplary arrangements for windowing by a radar transmitter, according to various embodiments of the present disclosure.

FIGS. 10-11 show different views of a delay-Doppler plane for a stationary object with a range corresponding to 1-μs RTT, based on no windowing and a transmitted radar signal using CE, according to some embodiments of the present disclosure.

FIGS. 12-13 show different views of a delay-Doppler plane for a stationary object with a range corresponding to 1-μs RTT, based on time-domain windowing and a transmitted radar signal using CE, according to other embodiments of the present disclosure.

FIGS. 14-15 show different views of a delay-Doppler plane for a stationary object with a range corresponding to 1-μs RTT, based on frequency-domain windowing and a transmitted radar signal using CE, according to other embodiments of the present disclosure.

FIGS. 16-17 show different views of a delay-Doppler plane for a stationary object with a range corresponding to 1-μs RTT, based on time-and frequency-domain windowing and a transmitted radar signal using CE, according to other embodiments of the present disclosure.

FIG. 18 shows a flow diagram of an exemplary method (e.g., procedure) for a radar receiver, according to various embodiments of the present disclosure.

FIG. 19 shows a flow diagram of an exemplary method (e.g., procedure) for a radar transmitter, according to various embodiments of the present disclosure.

FIG. 20 shows an exemplary device configurable as a radar transmitter and/or radar receiver, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

As briefly mentioned above, stationary objects such as buildings, parked vehicles, etc. often have large RCS due to size and/or material properties, such as amount of metal content. In some scenarios, however, the objective is to detect certain moving objects such as pedestrians, bicycles, etc. while the surrounding stationary objects are not of interest (“clutter”). This is made more difficult by the moving objects of interest having much lower RCS than the surrounding stationary objects. Thus, to be able to detect these moving objects, it is important that contributions (e.g., large peaks) from stationary clutter are very localized at zero Doppler in the delay-Doppler plane and have minimal spread or leakage into non-zero Doppler values.

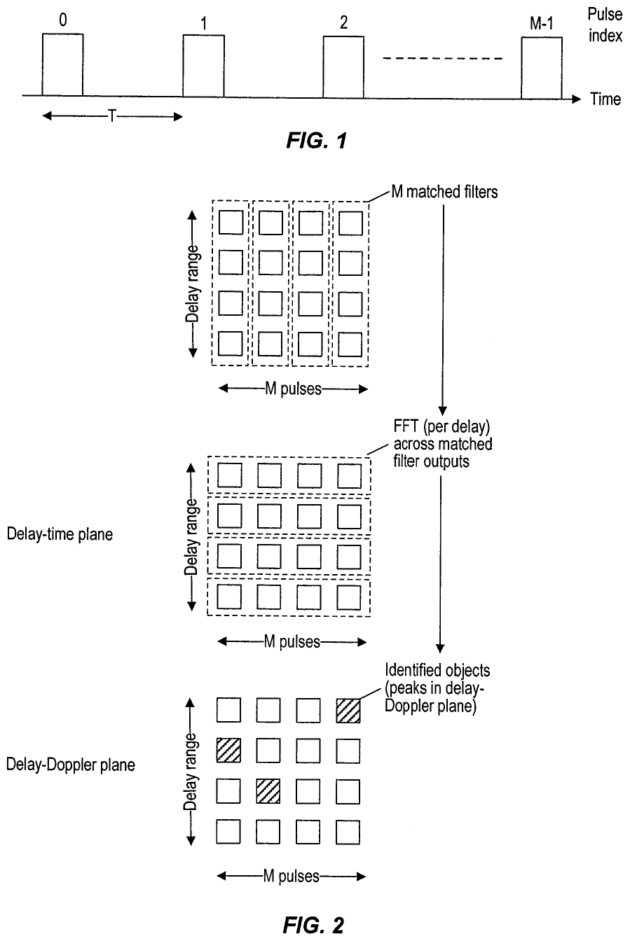

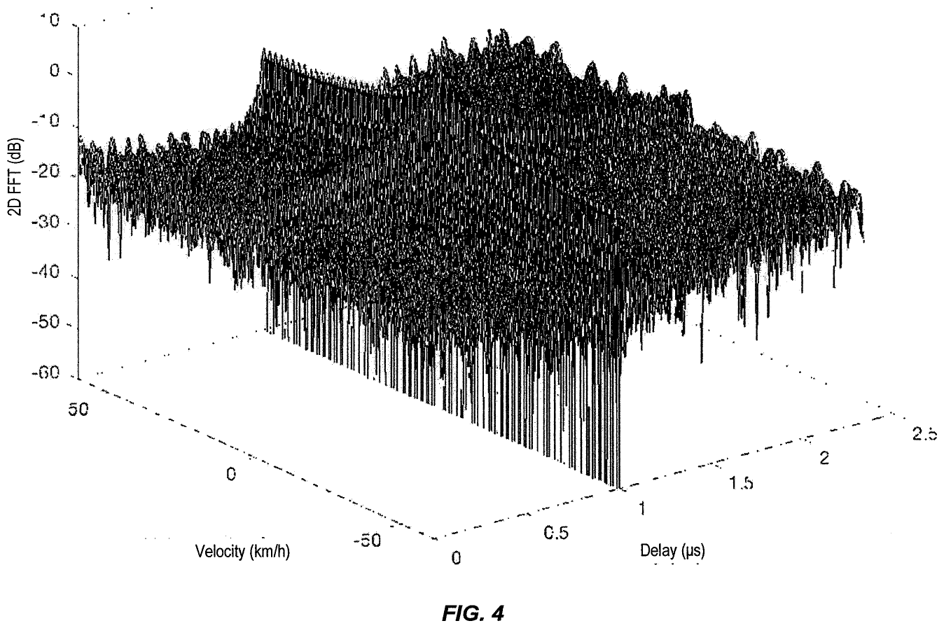

FIGS. 3-4 show different views of a delay-Doppler plane for a stationary object with a range corresponding to 1-μs RTT, based on a conventional transmitted radar signal. In particular, the transmitted radar signal consists of a train of pulses as depicted in FIG. 1, in which each pulse is a different Zadoff-Chu sequence that has been up-sampled to the chip rate of the radar transmitter. A peak is visible at 1 μs and zero Doppler, but sidelobes from this peak decay very slowly into non-zero Doppler regions. In this case, non-stationary (or moving) objects with smaller RCS and consequent weaker reflection can be masked by the sidelobes of the stronger delay-Doppler response from stationary clutter.

This can lead to misdetections of moving objects that are present. For example, in a traffic safety (e.g., autonomous driving) application where the goal is to detect to detect bicycles or other small vehicles strong stationary clutter from nearby buildings masks the desired targets and make them more difficult (or impossible) to detect. This can lead to accidents, crashes, and other catastrophic events.

Embodiments of the present disclosure address these and other problems, issues, and/or difficulties by transmitting radar signals comprising a sequence of pulses with cyclic extensions (CE). When implemented in combination with cyclic correlation in the receiver, radar pulses cyclically extended in this manner may better suppress stationary clutter in the delay-Doppler plane. In some embodiments, signal windowing in the time and/or frequency domains, in the transmitter and/or receiver, can or may be employed to further suppress stationary clutter.

Embodiments may provide various benefits and/or advantages. For example, embodiments may improve the suppression of clutter from stationary objects in the processing of echo signals by radar receivers, thereby improving the detection of non-stationary objects of interest that may be proximate to the stationary objects within the aperture of transmitted radar signal.

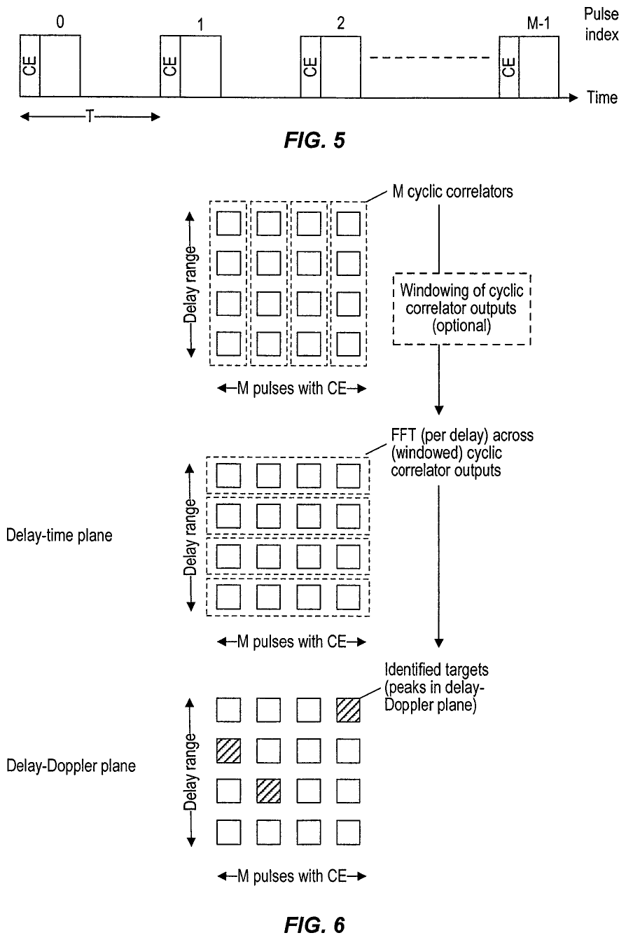

FIG. 5 illustrates an exemplary transmitted radar signal comprising a series of M pulses with CE, according to various embodiments of the present disclosure. Each pulse CE is identical and preferably long enough to capture echoes from objects at a maximum detection range (i.e., echoes with highest expected RTT). A CE that is too short to capture echoes of the transmitted signal will leads to performance degradation.

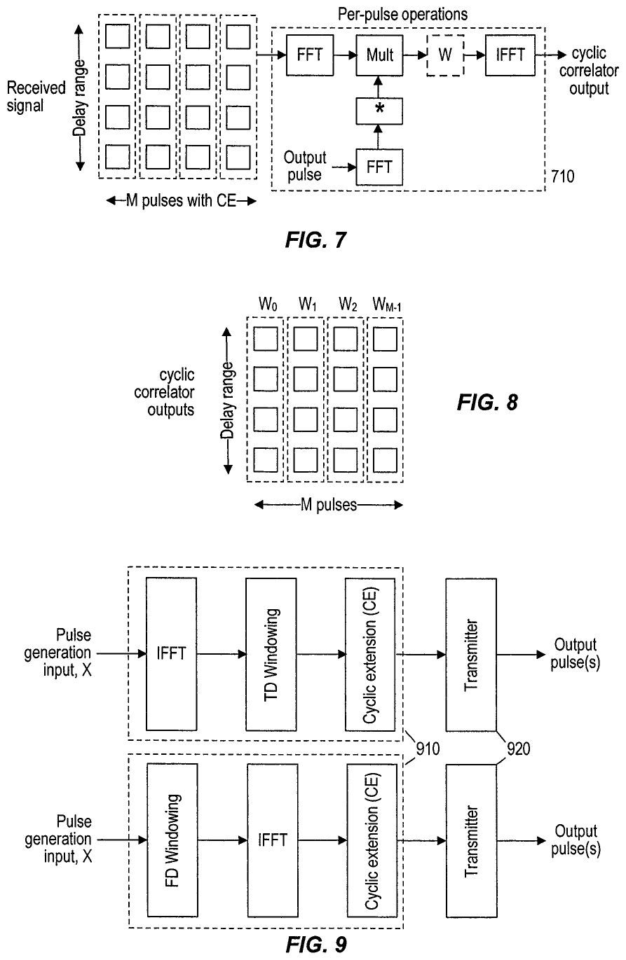

FIG. 6 illustrates exemplary radar receiver processing of a received composite signal comprising echoes of the M-pulse radar signal shown in FIG. 5. The receiver includes M cyclic correlators, each of which is applied to a signal stream with samples covering a range of delays of the corresponding pulse. The M cyclic correlators may be implemented as separate hardware units, a common hardware unit that performs all cyclic correlations, or a combination thereof.

The output of a cyclic correlation of a signal stream with a transmitted pulse (without CE) corresponds to a cyclic convolution between a periodic autocorrelation function (ACF) of the transmitted pulse (without CE) and the impulse response of the channel between transmitter and receiver (i.e., response of the objects). The output of a cyclic correlation may be referred to as a “correlation stream”. As explained in more detail below, pulses may be constructed to have very desirable (e.g., only one non-zero value) and identical periodic ACFs, even pulses that are different.

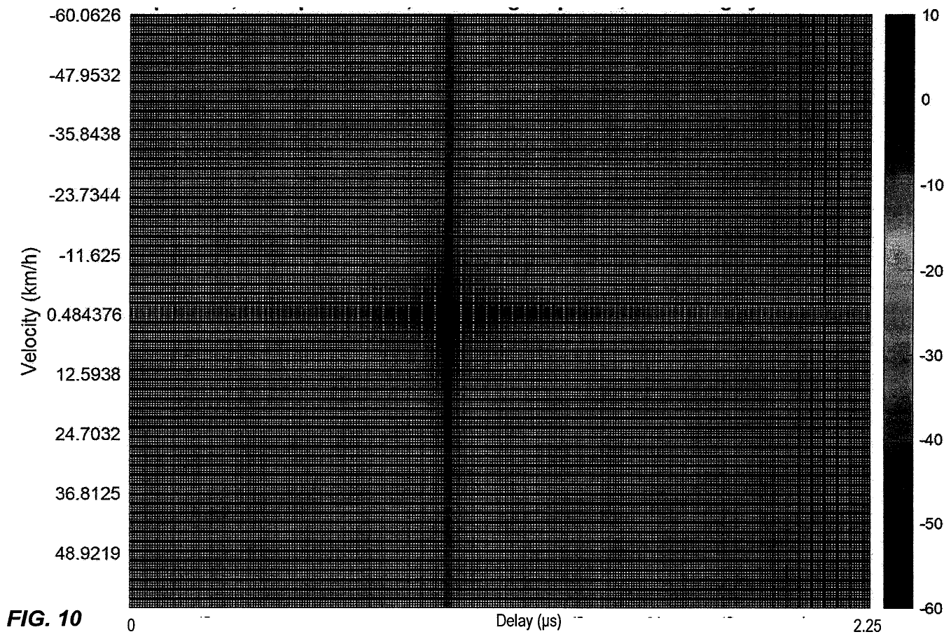

In some embodiments, the cyclic correlators may be realized as frequency-domain matched filters. FIG. 7 illustrates operation of an exemplary cyclic correlator 710 according to these embodiments. In this arrangement, each signal stream (per pulse) is converted to a frequency-domain representation using an FFT. This representation is then element-by-element multiplied by the complex conjugate of a frequency-domain representation (e.g., FFT) of the transmitted pulse (without cyclic extension). The product of these terms is then converted back into time-domain using an inverse FFT (IFFT). The size of the FFT is determined by the pulse length (without cyclic extension) and the sampling rate, while the IFFT size may be selected based on the desired range resolution. The output of the cyclic correlators is the 2D delay-time plane.

Subsequently, multiple FFTs are applied to the cyclic correlator outputs, with each FFT being applied to outputs from all M cyclic correlators corresponding to the same delay value or hypothesis. The output of the FFTs (i.e., the M correlation streams) is the 2D delay-Doppler plane.

As mentioned above, the output of a cyclic correlation of a received signal with a transmitted pulse (without CE) corresponds to a cyclic convolution between a periodic ACF of the transmitted pulse (without CE) and the impulse response of the objects. For stationary objects, the impulse response is constant and the periodic ACF does not vary across the M pulses. Thus, the output of each cyclic correlator is the same for a stationary object and each FFT input (corresponding to a particular delay value or hypothesis) consists of identical (or constant) values for all M pulses. The FFT then generates a corresponding output having a large value at zero Doppler and small or zero values at non-zero Dopplers, which reduce or eliminate masking of responses from moving objects at any of the non-zero Dopplers.

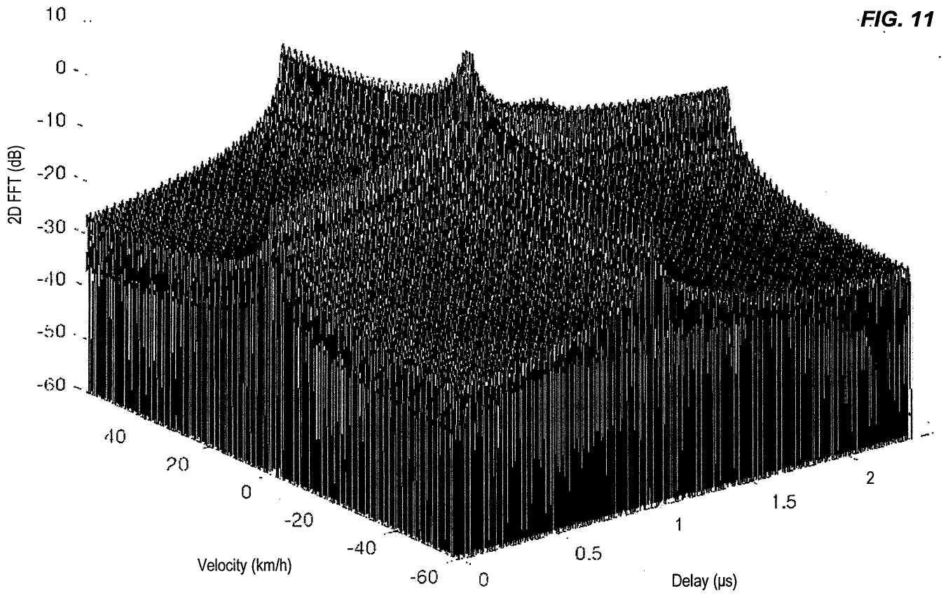

In some embodiments, windowing may be applied in the transmit and/or receive processing to further improve localization of a peak at zero Doppler. In the arrangement shown in FIG. 6, windowing may be applied to the outputs of the cyclic correlators (or equivalently to the inputs of the FFTs) in the radar receiver. FIG. 8 shows an exemplary arrangement for windowing by a radar receiver, according to some embodiments of the present disclosure. In this arrangement, respective window values W₀ . . . W_{M-1} are applied to respective correlation streams, i.e., all cyclic correlator outputs for a pulse are multiplied by the same window value. For example, outputs of cyclic correlators for intermediate pulses are multiplied by larger window values and outputs of cyclic correlators for earlier and later pulses (e.g., 0, M-1) are multiple by smaller window values. This arrangement can be thought of as time-domain windowing and can improve localization and decrease sidelobes of the stationary object at non-zero Dopplers.

In other embodiments or variants, windowing may be applied by the receiver in the frequency domain. For example, in the cyclic correlator realization shown in FIG. 7, a window function W may be inserted before the IFFT and after the element-by-element multiplication. From the time-domain perspective, this arrangement is equivalent to applying the same window value (e.g., one of W₀ . . . W_{M-1}) to the samples having the same index in all correlation streams. This arrangement can improve localization and decrease sidelobes of the stationary object at non-zero delays.

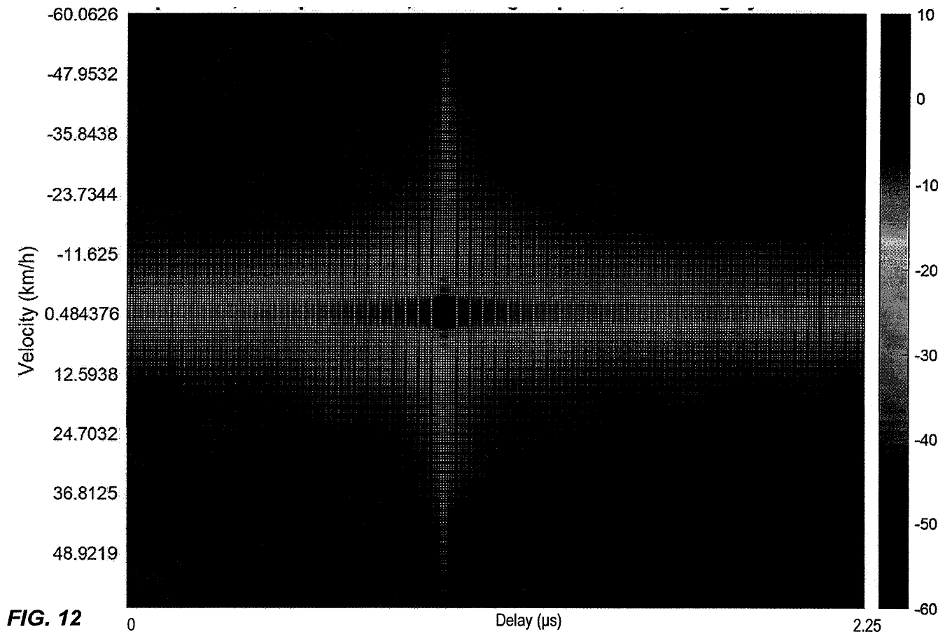

In other embodiments, time-or frequency-domain windowing may be applied by the transmitter. FIG. 9 shows two exemplary arrangements of windowing by a radar transmitter, according to various embodiments of the present disclosure. Both arrangements include processing circuitry 910 that performs the windowing and transmitter circuitry 920 that transmits the pulses produced by the windowing.

In the upper arrangement, windowing is performed in the time domain on the output of an IFFT that generates the pulse signals based on a frequency-domain pulse generation input, X. Although the figure shows windowing before the CE, the windowing may be applied after the CE instead. Transmitter-based time domain windowing reduces the energy in the transmitted signal due to scaling values of certain pulses. In cases where the radar transmitter has additional transmission power margin, this loss of energy may be compensated for by increasing the transmission power of all pulses.

In the lower arrangement, windowing is performed before the IFFT on the frequency-domain pulse generation input, X. By applying the windowing in the frequency-domain, the energy in each pulse may be maintained by scaling the window function, e.g., to amplify certain values to which it is applied.

In some embodiments, both transmitter and receiver may apply windowing. For example, a first part of the windowing (e.g., with frequency response wₜₓ(f)) can be applied in the transmitter and a second part of the windowing (e.g., with frequency response wᵣₓ(f)) can be applied in the receiver, with the total windowing being the product of the two parts w(f)=wₜₓ(f)*conj(wᵣₓ(f). In some variants, wₜₓ(f)=wᵣₓ(f).

A wide variety of window shapes with may be used, including Hamming, Hanning, Kaiser, etc. The choice of window shape may be based on balancing requirements for sidelobe suppression and width of the peak/main lobe.

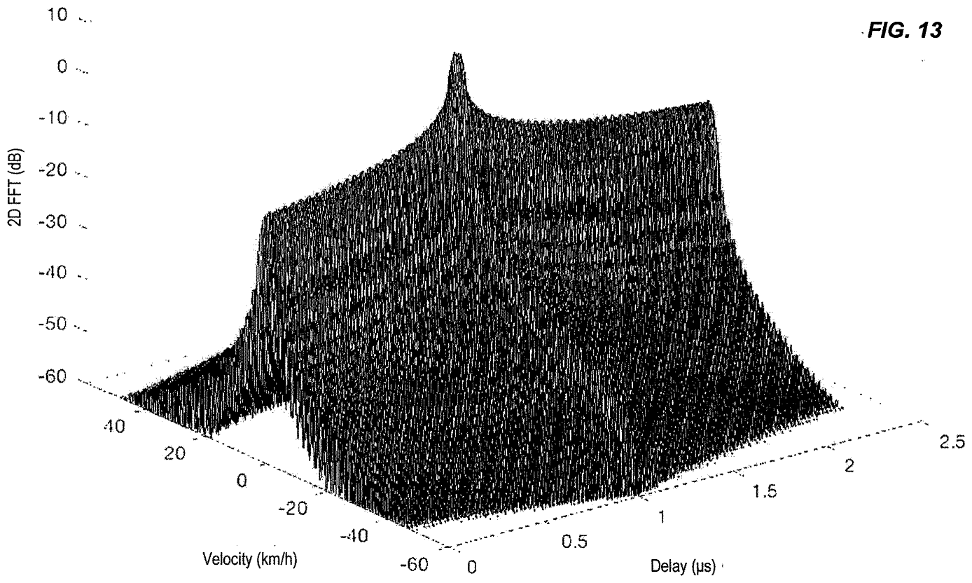

FIGS. 10-11 show different views of a delay-Doppler plane for a stationary object with a range corresponding to 1-μs RTT, based on no windowing and a transmitted radar signal with CE pulses, according to some embodiments of the present disclosure. Relative to performance of conventional non-CE pulses shown in FIGS. 3-4, CE pulses produce lower sidelobes in both delay/range and Doppler/velocity dimensions.

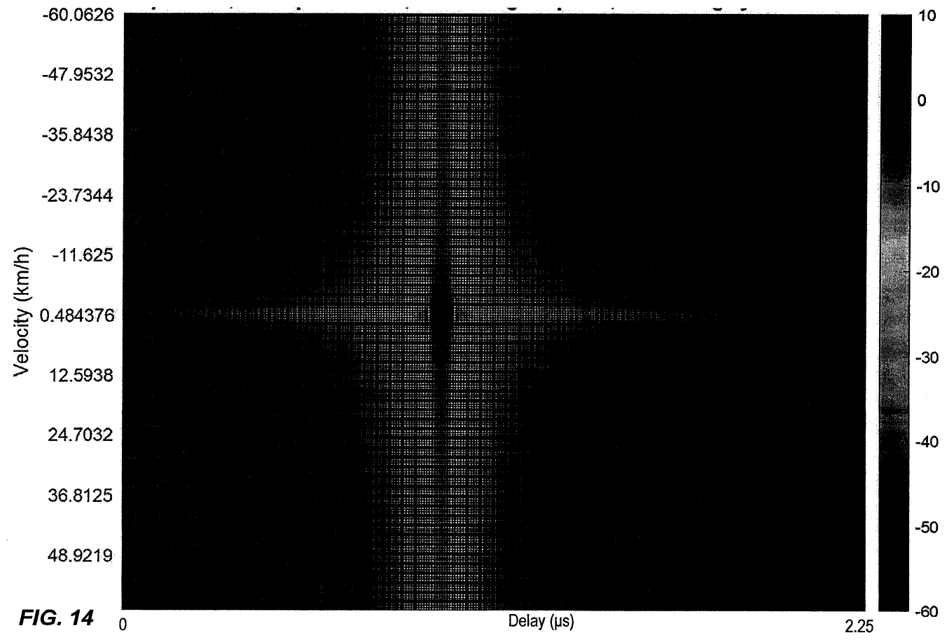

FIGS. 12-13 show different views of a delay-Doppler plane for a stationary object with a range corresponding to 1-μs RTT, based on time-domain Hanning windowing and a transmitted radar signal with CE pulses, according to other embodiments of the present disclosure. Relative to performance of non-windowed CE pulses shown in FIGS. 10-11, time-windowed CE pulses produce better localization of the main peak and lower sidelobes, particularly in Doppler/velocity dimension.

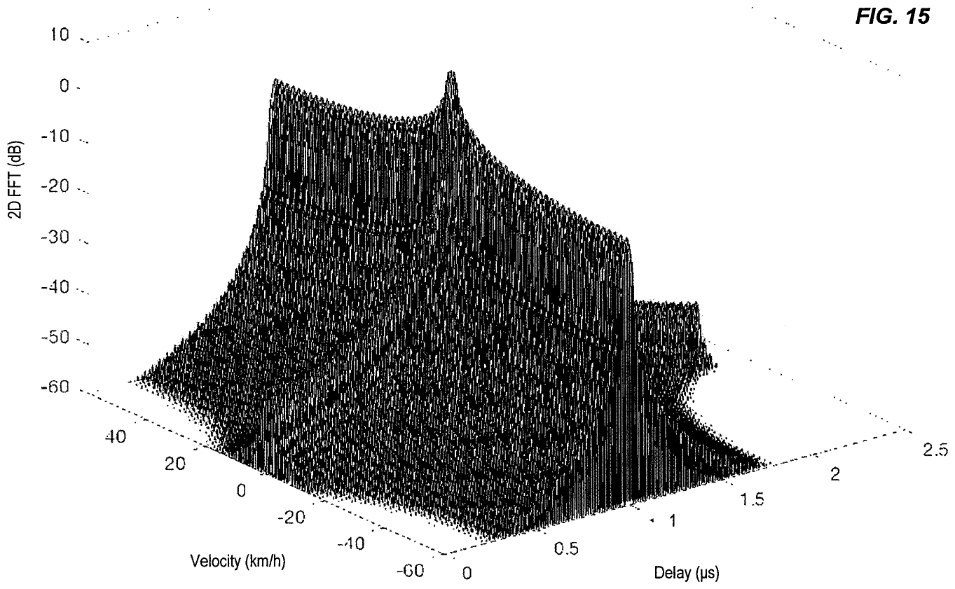

FIGS. 14-15 show different views of a delay-Doppler plane for a stationary object with a range corresponding to 1-μs RTT, based on frequency-domain Hanning windowing and a transmitted radar signal with CE pulses, according to other embodiments of the present disclosure. Relative to performance of non-windowed CE pulses shown in FIGS. 10-11, frequency-windowed CE pulses produce better localization of the main peak and lower sidelobes, particularly in delay/range dimension.

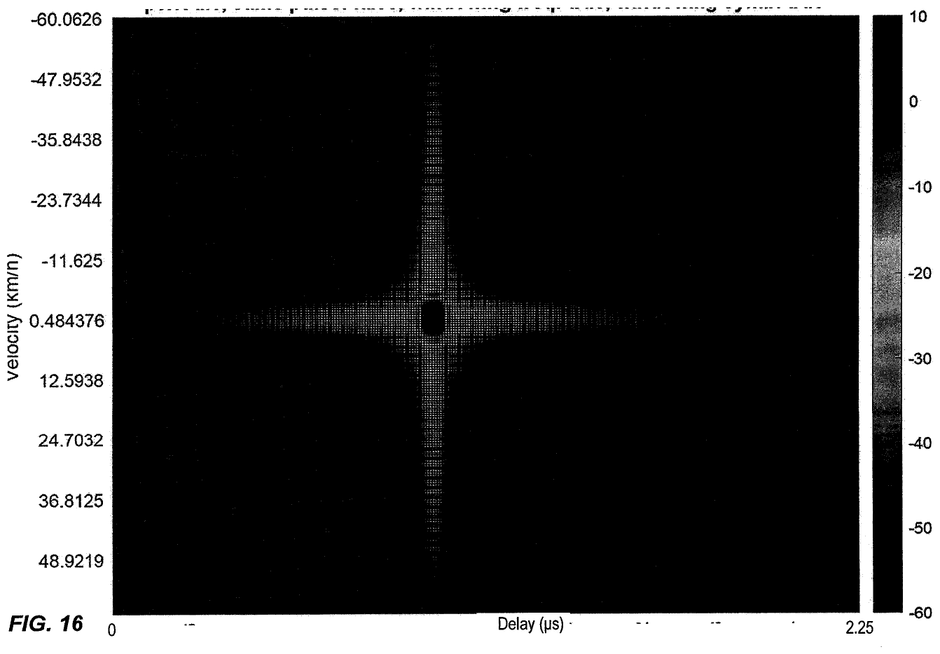

FIGS. 16-17 show different views of a delay-Doppler plane for a stationary object with a range corresponding to 1-μs RTT, based on time-and frequency-domain Hanning windowing and a transmitted radar signal with CE pulses, according to other embodiments of the present disclosure. Relative to performance of non-windowed CE pulses shown in FIGS. 10-11, time-and frequency-windowed CE pulses produce better localization of the main peak and lower sidelobes, in both Doppler/velocity and delay/range dimensions.

As briefly mentioned above, pulses may be constructed to have very desirable (e.g., only one non-zero value) and identical periodic ACFs, even pulses that are different. For example, the lower transmitter arrangement shown in FIG. 9 may be used to generate such pulses. A pulse generation input sequence, X, of (complex) numbers with constant modulus (or magnitude) is mapped to input bins of the IFFT (or the windowing function, if used). Examples of sequences with constant modulus include phase-modulated sequences such as quadrature phase shift keying (QPSK), binary phase shift keying (BPSK), Zadoff-Chu, etc. Each element of X is mapped to the same corresponding IFFT input bin for all generated pulses. To obtain a perfectly periodic ACF, the elements of X must be mapped to consecutive input bins of the IFFT. If the IFFT is longer (i.e., has more bins) than the number of elements in X, the non-used IFFT input bins are zeroed (i.e., the input is zero padded).

The periodic ACF of this signal is the IFFT of the squared magnitude of input sequence X, including any applied windowing and/or zero-padding to match IFFT size. Since all IFFT inputs have non-zero constant modulus (i.e., X) or are zero (i.e. for padding), the periodic ACF is identical regardless of the exact sequence X. This holds so long as non-zero elements of X have the same constant modulus and are mapped to the same IFFT input bins, and the same windowing is used. To maintain the cyclic properties even after passing through the wireless channel (which results in convolution of the transmitted signal with channel impulse response), each pulse needs to be cyclically extended prior to transmission, with the CE either prepended to the beginning or appended to the end of each pulse.

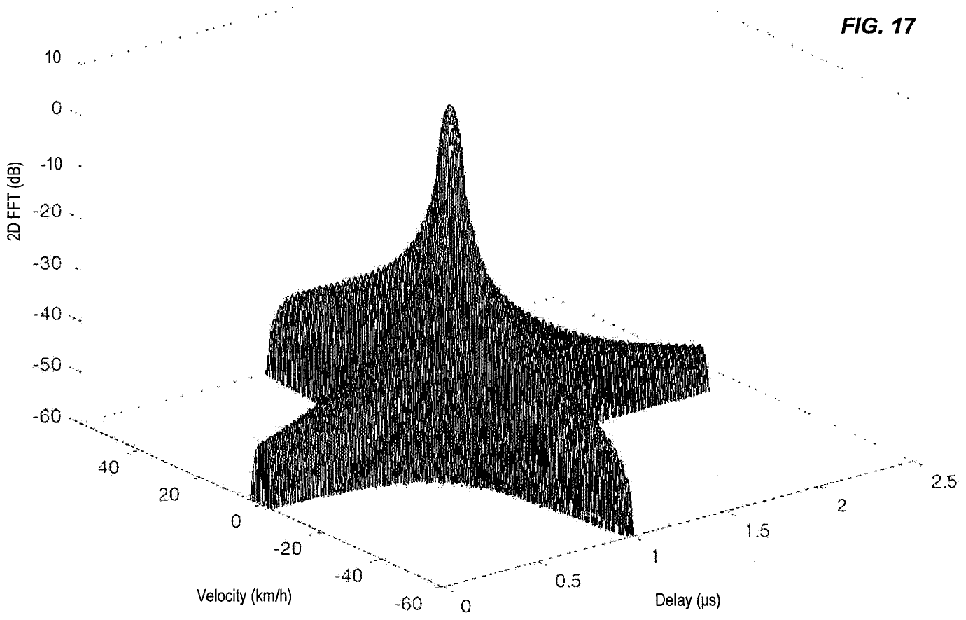

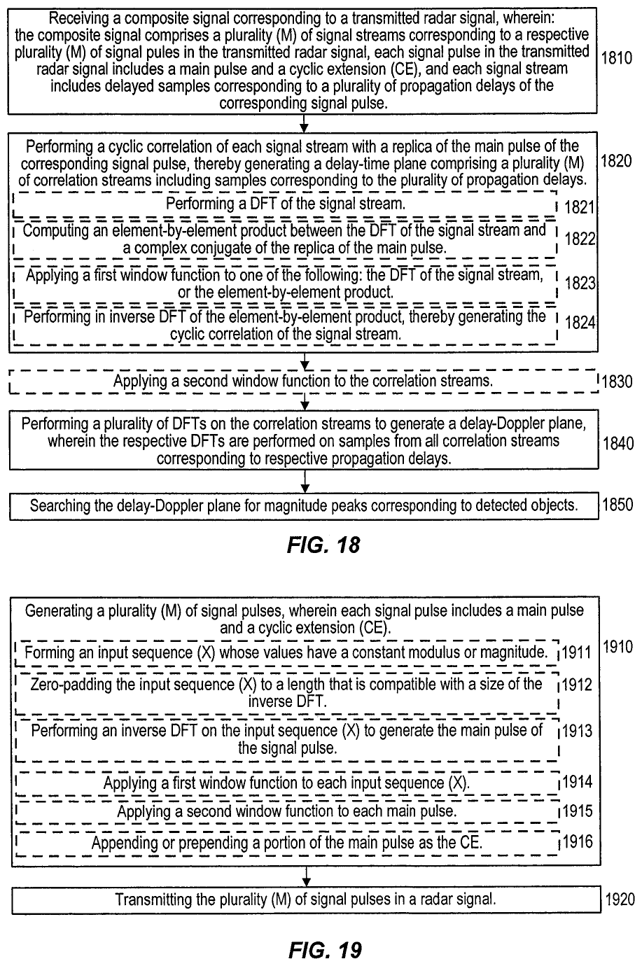

Various features of the embodiments described above correspond to various operations illustrated in FIGS. 18-19, which show exemplary methods (e.g., procedures) for a radar receiver and a radar transmitter, respectively. In other words, various features of the operations described below correspond to various embodiments described above. Furthermore, the exemplary methods shown in FIGS. 18-19 may be used cooperatively to provide various benefits, advantages, and/or solutions to problems described herein. Although FIGS. 18-19 show specific blocks in particular orders, the operations of the exemplary methods may be performed in different orders than shown and may be combined and/or divided into blocks having different functionality than shown. Optional blocks or operations are indicated by dashed lines.

In particular, FIG. 18 shows an exemplary method (e.g., procedure) for a radar receiver, according to various embodiments of the present disclosure. The exemplary method can or may be performed by any device or apparatus (e.g., wireless device, etc.) capable of receiving radar signals, such as described elsewhere herein.

The exemplary method includes the operations of block 1810, where the radar receiver receives a composite signal corresponding to a transmitted radar signal. The composite signal comprises a plurality (M) of signal streams corresponding to a respective plurality (M) of signal pulses in the transmitted radar signal. Each signal pulse in the transmitted signal includes a main pulse and a cyclic extension (CE). Each signal stream includes delayed samples corresponding to a plurality of propagation delays of the corresponding signal pulse. In other words, each signal stream includes samples covering delayed copies of the corresponding signal pulse.

The exemplary method also includes the operations of block 1820, where the radar receiver performs a cyclic correlation of each signal stream with a replica of the main pulse of the corresponding signal pulse, thereby generating a delay-time plane comprising a plurality (M) of correlation streams including samples corresponding to the plurality of propagation delays. The exemplary method also includes the operations of block 1840, where the radar receiver performs a plurality of discrete Fourier transforms (DFTs, e.g., FFTs) on the correlation streams to generate a delay-Doppler plane. The respective DFTs are performed on samples from all correlation streams corresponding to respective propagation delays. The exemplary method also includes the operations of block 1850, where the radar receiver searches the delay-Doppler plane for magnitude peaks corresponding to detected objects.

In some embodiments, based on the searching in block 1850, one or more objects are detected in the delay-Doppler plane, e.g., at non-zero Doppler values. Some examples of detection at non-zero Doppler were discussed above. In some embodiments, the CEs of the plurality (M) of signal pulses have a common length (i.e., all have the same length), with the common length being sufficient to capture echoes from objects at a maximum detection range. For example, the common length can be at least as long as time difference between a first echo peak and a last echo peak.

In some embodiments, the main pulses of the plurality (M) of signal pulses are based on a corresponding plurality (M) of input sequences that have a common periodic ACF (i.e., all have the same periodic ACF), which includes a single non-zero value. In some embodiments, each main pulse of the plurality (M) of signal pulses is based on an input sequence (X) whose values have a constant modulus or magnitude. In some of these embodiments, each input sequence (X), on which one or more of the main pulses are based, is one of the following: quadrature phase shift keying (QPSK) sequence, binary phase shift keying (BPSK) sequence, or Zadoff-Chu sequence.

In some embodiments, performing the cyclic correlation of each signal stream with the replica of the main pulse of the corresponding signal pulse in block 1820 includes the following operations for each signal stream, labelled with corresponding sub-block numbers
(1821) performing a DFT (e.g., FFT) of the signal stream;
(1822) computing an element-by-element product between the DFT of the signal stream and a complex conjugate of the replica of the main pulse; and
(1824) performing in inverse DFT (e.g., IFFT) of the element-by-element product, thereby generating the cyclic correlation of the signal stream.

In some of these embodiments, performing the cyclic correlation of each signal stream with the replica of the main pulse of the corresponding signal pulse in block 1820 also includes the operations of sub-block 1823 for each signal stream, where the radar receiver applies a first window function to one of the following: the DFT of the signal stream, or the element-by-element product. In some variants, the first window function is configured to improve localization of objects in a delay dimension of the delay-Doppler plane, relative to when the first window function is not applied. In some variants, the first window function is configured to be complementary to a third window function configured to be applied to each main pulse of the plurality (M) of signal pulses included in the transmitted radar signal.

In some embodiments, the exemplary method also includes the operations of block 1830, where the radar receiver applies a second window function to the correlation streams. Respective values of the second window function are applied to all samples of respective correlation streams and the plurality of DFTs are performed on the windowed correlation streams. In some of these embodiments, the second window function is configured to improve localization of objects in a Doppler dimension of the delay-Doppler plane, relative to when the second window function is not applied. In some of these embodiments, the second window function is configured to be complementary to a fourth window function configured to be applied to each main pulse of the plurality (M) of signal pulses included in the transmitted radar signal.

Furthermore, FIG. 19 shows an exemplary method (e.g., procedure) for a radar transmitter, according to various embodiments of the present disclosure. The exemplary method can or may be performed by any device or apparatus (e.g., wireless device, etc.) capable of transmitting radar signals, such as described elsewhere herein.

The exemplary method includes the operations of block 1910, where the radar transmitter generates a plurality (M) of signal pulses. Each signal pulse includes a main pulse and a cyclic extension (CE). The exemplary method also includes the operations of block 1920, where the radar transmitter transmits the plurality (M) of signal pulses in a radar signal.

In some embodiments, the CEs of the plurality (M) of signal pulses have a common length (i.e., all have the same length), with the common length being sufficient to capture echoes from objects at a maximum detection range. For example, the common length can be at least as long as time difference between a first echo peak and a last echo peak. In some embodiments, the main pulses of the plurality (M) of signal pulses are based on a corresponding plurality (M) of input sequences that have a common periodic ACF (i.e., all have the same periodic ACF), which includes a single non-zero value. In some embodiments, generating the plurality (M) of signal pulses in block 1910 includes the following operations for each signal pulse, labelled with corresponding sub-block numbers:
(1911) forming an input sequence (X) whose values have a constant modulus or magnitude;
(1913) performing an inverse discrete Fourier transform (DFT) on the input sequence (X) to generate the main pulse of the signal pulse; and
(1916) appending or prepending a portion of the main pulse as the CE.

In some of these embodiments, each input sequence (X) is one of the following: QPSK sequence, BPSK sequence, or Zadoff-Chu sequence. In some of these embodiments, generating the plurality (M) of signal pulses in block 1910 also includes the operations of sub-block 1912 for each signal pulse, where the radar transmitter can or may, when needed, zero-pad the input sequence (X) to a length that is compatible with a size of the inverse DFT. In some of these embodiments, generating the plurality (M) of signal pulses in block 1910 also includes one or more of the following operations, labelled with corresponding sub-block numbers:
(1914) applying a first window function to each input sequence (X) before performing the inverse DFT; and
(1915) applying a second window function to each main pulse of the plurality (M) of signal pulses, before appending or prepending the respective portions of the main pulses as the CEs.

In some variants, the second window function includes a plurality (M) of values corresponding respectively to the plurality (M) of signal pulses. Each of the values is applied to all samples of the main pulse of the corresponding signal pulse.

In some variants, the first window function is configured to improve localization of objects by radar receivers in a delay dimension of a delay-Doppler plane, relative to when the first window function is not applied. In some variants, the second window function is configured to improve localization of objects by radar receivers in a Doppler dimension of the delay-Doppler plane, relative to when the second window function is not applied.

In some variants, the first window function is configured to be complementary to a third window function configured to be applied to echoes of the transmitted radar signal that are received by radar receivers. In some variants, the second window function is configured to be complementary to a fourth window function configured to be applied to echoes of the transmitted radar signal that are received by radar receivers.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

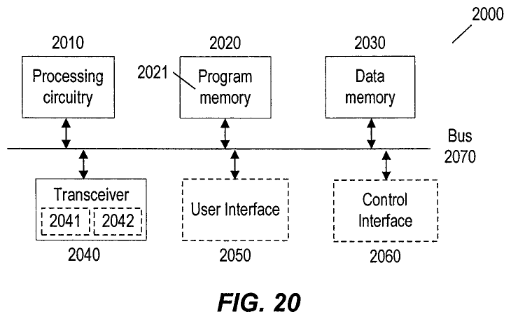

FIG. 20 shows a block diagram of an exemplary device configurable according to various embodiments of the present disclosure, including by execution of instructions on a computer-readable medium that correspond to, or comprise, any of the exemplary methods and/or procedures described above. For example, device 2000 can or may be configured as a radar receiver, a radar transmitter, or as a radar transmitter/receiver (“transceiver”).

Device 2000 comprises processing circuitry 2010 that can be operably connected to a program memory 2020 and/or a data memory 2030 via a bus 2070 that can comprise parallel address and data buses, serial ports, or other methods and/or structures known to those of ordinary skill in the art. Program memory 2020 can store software code, programs, and/or instructions (collectively shown as computer program product 2021 in FIG. 20) executed by processing circuitry 2010 that can configure and/or facilitate device 2000 to perform operations corresponding to various methods or procedures described herein. For example, execution of computer program product 2021 can configure device 2000 to perform operations attributed to a radar receiver and/or to a radar transmitter in the above descriptions related to other figures.

In some embodiments, program memory 2020 can store software code, programs, and/or instructions that can facilitate device 2000 to communicate with various Fifth Generation/New Radio (5G/NR), Fourth Generation/Long Term Evolution (4G/LTE), Third Generation/General Universal Mobile Telecommunications System (3G/UMTS), Second Generation/Global System for Mobile Communications/General Packet Radio Service (2G/GSM/GPRS), etc. networks according to standards promulgated by 3rd Generation Partnership Project (3GPP). In some embodiments, program memory 2020 can store software code, programs, and/or instructions that can facilitate device 2000 to communicate with various Wireless Fidelity (WiFi) networks according to standards promulgated by Institute of Electrical and Electronics Engineers (IEEE). In some embodiments, program memory 2020 can store software code, programs, and/or instructions that can facilitate device 2000 to communicate with other devices or networks via radio-frequency technologies such as Bluetooth, Zigbee, Global Navigation Satellite Systems (GNSS), such as GPS, etc.

Program memory 2020 can also include software code executed by processing circuitry 2010 to control the function of device 2000, including configuring and controlling various components such as transceiver 2040, user interface 2050 (optional), and/or control interface 2060 (optional). Program memory 2020 can also comprise one or more application programs and/or modules comprising computer-executable instructions embodying any of the exemplary methods and/or procedures described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 2020 can comprise an external storage arrangement (not shown) remote from device 2000, from which the instructions can be downloaded into program memory 2020 located within or removably coupled to device 2000, so as to enable execution of such instructions.

Data memory 2030 can comprise memory area for processing circuitry 2010 to store variables used in protocols, configuration, control, and other functions of device 2000, including operations corresponding to, or comprising, any of the exemplary methods and/or procedures described herein. Moreover, program memory 2020 and/or data memory 2030 can comprise non-volatile memory (e.g., flash memory), volatile memory (e.g., static or dynamic RAM), or a combination thereof. Furthermore, data memory 2030 can comprise a memory slot by which removable memory cards in one or more formats (e.g., SD Card, Memory Stick, Compact Flash, etc.) can be inserted and removed.

Processing circuitry 2010 can include one or more individual processors (including, e.g., multi-core processors), each of which implements a portion of the functionality described above. Multiple individual processors can be commonly connected to program memory 2020 and data memory 2030 or individually connected to multiple individual program memories and or data memories. More generally, persons of ordinary skill in the art will recognize that device 2000 can comprise various computing arrangements having different combinations of processing circuitry and software including, but not limited to, application processors, signal processors, general-purpose processors, multi-core processors, ASICs, fixed and/or programmable digital circuitry, analog baseband circuitry, radio-frequency circuitry, software, firmware, and middleware.

Transceiver 2040 can or may include radio-frequency transmitter circuitry 2041 and/or radio-frequency receiver circuitry 2042 that facilitates device 2000 to transmit and/or receive radar signals according to various embodiments described above. For example, such circuitry can include mixers, power amplifiers, low-noise amplifiers, filters, antennas, etc.

In some embodiments, transceiver 2040 can include radio-frequency transmitter and/or receiver circuitry that can facilitate device 2000 to communicate with various 5G/NR,4G/LTE, 3G/UMTS, 2G/GSM/GPRS, etc. networks according to standards promulgated by 3GPP and/or with WiFi networks according to standards promulgated by IEEE. In different variants, this radio-frequency transmitter and/or receiver circuitry can be the same as, include parts of, or be different than radio-frequency transmitter circuitry 2041 and/or radio-frequency receiver circuitry 2042.

In some embodiments, transceiver 2040 can include radio-frequency transmitter and/or receiver circuitry that can facilitate device 2000 to communicate with other devices or networks via radio-frequency technologies such as Bluetooth, Zigbee, GNSS (e.g., GPS), etc. In different variants, this radio-frequency transmitter and/or receiver circuitry can be the same as, include parts of, or be different than radio-frequency transmitter circuitry 2041 and/or radio-frequency receiver circuitry 2042.

User interface 2050 can take various forms depending on the particular embodiment of device 2000, or can be absent from device 2000 entirely. In some embodiments, user interface 2050 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the device 2000 can comprise a tablet computing device including a larger touchscreen display. In such embodiments, one or more of the mechanical features of the user interface 2050 can be replaced by comparable or functionally equivalent virtual user interface features (e.g., virtual keypad, virtual buttons, etc.) implemented using the touchscreen display, as familiar to persons of ordinary skill in the art. In other embodiments, the device 2000 can be a digital computing device, such as a laptop computer, desktop computer, workstation, etc. that comprises a mechanical keyboard that can be integrated, detached, or detachable depending on the particular embodiment. Such a digital computing device can also comprise a touch screen display. Many embodiments of the device 2000 having a touch screen display are capable of receiving user inputs, such as inputs related to exemplary methods and/or procedures described herein or otherwise known to persons of ordinary skill in the art.

In some embodiments, device 2000 can include an orientation sensor, which can be used in various ways by features and functions of device 2000. For example, the device 2000 can use outputs of the orientation sensor to determine when a user has changed the physical orientation of the device 2000's touch screen display. An indication signal from the orientation sensor can be available to any application program executing on the device 2000, such that an application program can change the orientation of a screen display (e.g., from portrait to landscape) automatically when the indication signal indicates an approximate 90-degree change in physical orientation of the device. In this manner, the application program can maintain the screen display in a manner that is readable by the user, regardless of the physical orientation of the device. In addition, the output of the orientation sensor can be used in conjunction with various embodiments of the present disclosure.

When present in device 2000, control interface 2060 can take various forms depending on the particular embodiment of device 2000 and the particular interface requirements of other devices that the device 2000 is intended to communicate with and/or control. For example, the control interface 2060 can comprise an RS-232 interface, an RS-485 interface, a USB interface, an HDMI interface, a Bluetooth interface, an IEEE (“Firewire”) interface, an I2C interface, a PCMCIA interface, or the like. In some embodiments of the present disclosure, control interface 2060 can comprise an IEEE 802.3 Ethernet interface such as described above. In some embodiments of the present disclosure, the control interface 2060 can comprise analog interface circuitry including, for example, one or more digital-to-analog (D/A) and/or analog-to-digital (A/D) converters.

Persons of ordinary skill in the art can recognize that the above list of features, interfaces, and radio-frequency communication standards is merely exemplary, and not limiting to the scope of the present disclosure. In other words, the device 2000 can comprise more functionality than is shown in FIG. 20 including, for example, a video and/or still-image camera, microphone, media player and/or recorder, etc. Moreover, the processing circuitry 2010 can execute software code stored in the program memory 2020 to control such additional functionality. For example, directional velocity and/or position estimates output from a GPS receiver can be available to any application program executing on the device 2000, including various exemplary methods and/or computer-readable media according to various embodiments of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a radar receiver, the method comprising:
receiving a composite signal corresponding to a transmitted radar signal, wherein:
   the composite signal comprises a plurality (M) of signal streams corresponding to a respective plurality (M) of signal pulses in the transmitted radar signal,
   each signal pulse in the transmitted signal includes a main pulse and a cyclic extension (CE), and
   each signal stream includes samples corresponding to a plurality of propagation delays of the corresponding signal pulse;
performing a cyclic correlation of each signal stream with a replica of the main pulse of the corresponding signal pulse, thereby generating a delay-time plane comprising a plurality (M) of correlation streams including samples corresponding to the plurality of propagation delays;
performing a plurality of discrete Fourier transforms (DFTs) on the correlation streams to generate a delay-Doppler plane, wherein the respective DFTs are performed on samples from all correlation streams corresponding to respective propagation delays; and
detecting one or more objects located at non-zero Doppler values in the delay-Doppler plane.
   A2. The method of embodiment A1, wherein the plurality (M) of CEs have the same length, which is sufficient to capture echoes from objects at a maximum detection range.
   A3. The method of any of embodiments A1-A2, wherein the plurality (M) of main pulses have the same periodic autocorrelation function (ACF), which includes a single non-zero value.
   A4. The method of any of embodiments A1-A3, wherein each of the plurality (M) of main pulses is based on an input sequence (X) whose values have a constant modulus or magnitude.
   A5. The method of any of embodiments A1-A4, wherein each input sequence (X), on which one or more of the main pulses are based, is one of the following: quaternary phase shift keying (QPSK) sequence, binary phase shift keying (BPSK) sequence, or Zadoff-Chu sequence.
   A6. The method of any of embodiments A1-A5, wherein performing the cyclic correlation of each signal stream with the replica of the main pulse of the corresponding signal pulse comprises, for each signal stream:
performing a DFT of the signal stream;
computing an element-by-element product between the DFT of the signal stream and a complex conjugate of the replica of the main pulse; and
performing in inverse DFT of the element-by-element product, thereby generating the cyclic correlation of the signal stream.
   A7. The method of embodiment A6, wherein performing the cyclic correlation of each signal stream with the replica of the main pulse of the corresponding signal pulse further comprises, for each signal stream, applying a first window function to one of the following: the DFT of the signal stream, or the element-by-element product.
   A8. The method of embodiment A7, wherein the first window function is configured to improve localization of objects in the delay dimension of the delay-Doppler plane.
   A9. The method of any of embodiments A1-A8, further comprising applying a second window function to the correlation streams, wherein:
respective values of the second window function are applied to all samples of respective correlation streams; and
the plurality of DFTs are performed on the windowed correlation streams.
   A10. The method of embodiment A9, wherein the second window function is configured to improve localization of objects in the Doppler dimension of the delay-Doppler plane.
   A11. The method of any of embodiments A7-A10, wherein one or more window functions applied by the radar receiver are configured to be complementary to a third window function applied to each of the plurality (M) of main pulses included in the transmitted radar signal.
   B1. A method for a radar transmitter, the method comprising:
generating a plurality (M) of signal pulses, wherein each signal pulse includes a main pulse and a cyclic extension (CE); and
transmitting the plurality (M) of signal pulses in a radar signal.
   B2. The method of embodiment B1, wherein the plurality (M) of CEs have the same length, which is sufficient to capture echoes from objects at a maximum detection range.
   B3. The method of any of embodiments B1-B2, wherein the plurality (M) of main pulses have the same periodic autocorrelation function (ACF), which includes a single non-zero value.
   B4. The method of any of embodiments B1-B3, wherein generating the plurality (M) of signal pulses comprises, for each signal pulse:
forming an input sequence (X) whose values have a constant modulus or magnitude;
performing an inverse discrete Fourier transform (DFT) on the input sequence (X) to generate the main pulse of the signal pulse; and
appending or prepending a portion of the main pulse as the CE.
   B5. The method of embodiment B4, wherein each input sequence (X) is one of the following: quaternary phase shift keying (QPSK) sequence, binary phase shift keying (BPSK) sequence, or Zadoff-Chu sequence.
   B6. The method of any of embodiments B4-B5, generating the plurality (M) of signal pulses further comprises, for each signal pulse, zero-padding the input sequence (X) to a length that is compatible with a size of the inverse DFT.
   B7. The method of any of embodiments B4-B6, wherein generating the plurality (M) of signal pulses further comprises, for each signal pulse, applying one or more of the following:
a first window function to the input sequence (X) before performing the inverse DFT; or
a second window function to the main pulse before appending or prepending the portion as the CE.
   B8. The method of embodiment B7, wherein one or more of the following applies:
the first window function is configured to improve localization of objects by radar receivers in a delay dimension of a delay-Doppler plane; and
the second window function is configured to improve localization of objects by radar receivers in a Doppler dimension of the delay-Doppler plane.
   B9. The method of any of embodiments B7-B8, wherein the first window function and/or the second window function is configured to be complementary to a third window function applied to echoes of the transmitted radar signal that are received by radar receivers.
   C1. A radar receiver, comprising:
receiver circuitry configured to receive echoes of transmitted radar signals; and
processing circuitry operatively coupled to the receiver circuitry, whereby the processing circuitry and the receiver circuitry are configured to perform operations corresponding to any of the methods of embodiments A1-A11.
   C2. A radar receiver configured to perform operations corresponding to any of the methods of embodiments A1-A11.
   C3. A non-transitory, computer-readable medium storing computer-executable instructions that, when executed by processing circuitry of a radar receiver, configure the radar receiver to perform operations corresponding to any of the methods of embodiments A1-A11.
   C4. A computer program product comprising computer-executable instructions that, when executed by processing circuitry of a radar receiver, configure the radar receiver to perform operations corresponding to any of the methods of embodiments A1-A11.

### D1. a Radar Transmitter, Comprising:

transmitter circuitry configured to transmit radar signals; and
processing circuitry operatively coupled to the transmitter circuitry, whereby the processing circuitry and the transmitter circuitry are configured to perform operations corresponding to any of the methods of embodiments B1-B9.
   D2. A radar transmitter configured to perform operations corresponding to any of the methods of embodiments B1-B9.
   D3. A non-transitory, computer-readable medium storing computer-executable instructions that, when executed by processing circuitry of a radar transmitter, configure the radar transmitter to perform operations corresponding to any of the methods of embodiments B1-B9.
   D4. A computer program product comprising computer-executable instructions that, when executed by processing circuitry of a radar transmitter, configure the radar transmitter to perform operations corresponding to any of the methods of embodiments B1-B9.

### E1. a Radar Transceiver Comprising:

the radar receiver of any of embodiments C1-C2; and
the radar transmitter of any of embodiments D1-D2,
wherein the radar receiver is configured to receive echoes of radar signals transmitted by the radar transmitter.
   E2. A non-transitory, computer-readable medium storing computer-executable instructions that, when executed by processing circuitry of a radar transceiver, configure the radar transceiver to perform operations corresponding to any of the methods of embodiments A1 -A11 and any of the methods of embodiments B1-B9.
   E3. A computer program product comprising computer-executable instructions that, when executed by processing circuitry of a radar transceiver, configure the radar transceiver to perform operations corresponding to any of the methods of embodiments A1 -A11 and any of the methods of embodiments B1-B9.

1.-38. (canceled)

39. A method for a radar receiver, the method comprising:
receiving a composite signal corresponding to a transmitted radar signal, wherein:
the composite signal comprises a plurality (M) of signal streams corresponding to a respective plurality (M) of signal pulses in the transmitted radar signal,
each signal pulse in the transmitted radar signal includes a main pulse and a cyclic extension (CE), and
each signal stream includes delayed samples corresponding to a plurality of propagation delays of the corresponding signal pulse;
performing a cyclic correlation of each signal stream with a replica of the main pulse of the corresponding signal pulse, thereby generating a delay-time plane comprising a plurality (M) of correlation streams including samples corresponding to the plurality of propagation delays;
performing a plurality of discrete Fourier transforms (DFTs) on the correlation streams to generate a delay-Doppler plane, wherein the respective DFTs are performed on samples from all correlation streams corresponding to respective propagation delays; and
searching the delay-Doppler plane for magnitude peaks corresponding to detected objects.

40. The method of claim 39, wherein based on the searching, one or more objects are detected at non-zero Doppler values in the delay-Doppler plane.

41. The method of claim 39, wherein performing the cyclic correlation of each signal stream with the replica of the main pulse of the corresponding signal pulse comprises, for each signal stream:
performing a DFT of the signal stream;
computing an element-by-element product between the DFT of the signal stream and a complex conjugate of the replica of the main pulse; and
performing an inverse DFT of the element-by-element product, thereby generating the cyclic correlation of the signal stream.

42. The method of claim 41, wherein performing the cyclic correlation of each signal stream with the replica of the main pulse of the corresponding signal pulse further comprises, for each signal stream, applying a first window function to one of the following:
the DFT of the signal stream, or
the element-by-element product between the DFT of the signal stream and the complex conjugate of the replica of the main pulse.

43. The method of claim 42, wherein the first window function is configured to be complementary to a third window function configured to be applied to each main pulse of the plurality (M) of signal pulses included in the transmitted radar signal.

44. The method of claim 39, further comprising applying a second window function to the correlation streams thereby generating windowed correlation streams, wherein:
respective values of the second window function are applied to all samples of respective correlation streams; and
the plurality of DFTs are performed on the windowed correlation streams.

45. The method of claim 44, wherein the second window function is configured to be complementary to a fourth window function configured to be applied to each main pulse of the plurality (M) of signal pulses included in the transmitted radar signal.

46. A method for a radar transmitter, the method comprising:
generating a plurality (M) of signal pulses, wherein each signal pulse includes a main pulse and a cyclic extension, CE; and
transmitting the plurality (M) of signal pulses in a radar signal.

47. The method of claim 46, wherein one or more of the following applies:
the CEs of the plurality (M) of signal pulses have a common length, with the common length being sufficient to capture echoes from objects at a maximum detection range; and
the main pulses of the plurality (M) of signal pulses are based on a corresponding plurality (M) of input sequences that have a common periodic autocorrelation function, ACF, which includes a single non-zero value.

48. The method of claim 46, wherein generating the plurality (M) of signal pulses comprises, for each signal pulse:
forming an input sequence (X) whose values have a constant modulus or magnitude;
performing an inverse discrete Fourier transform (DFT) on the input sequence (X) to generate the main pulse of the signal pulse; and
appending or prepending a portion of the main pulse as the CE.

49. The method of claim 48, wherein each input sequence (X) is one of the following:
quadrature phase shift keying, QPSK, sequence; binary phase shift keying, BPSK, sequence; or Zadoff-Chu sequence.

50. The method of claim 48, wherein generating the plurality (M) of signal pulses further comprises, for each signal pulse, zero-padding the input sequence (X) to a length that is compatible with a size of the inverse DFT.

51. The method of claim 48, wherein generating the plurality (M) of signal pulses further comprises one or more of the following:
applying a first window function to each input sequence (X) before performing the inverse DFT; and
applying a second window function to each main pulse of the plurality (M) of signal pulses, before appending or prepending the respective portions of the main pulses as the CEs.

52. The method of claim 51, wherein the second window function includes a plurality (M) of values corresponding respectively to the plurality (M) of signal pulses, with each of the values being applied to all samples of the main pulse of the corresponding signal pulse.

53. The method of claim 51, wherein one or more of the following applies:
the first window function is configured to improve localization of objects by radar receivers in a delay dimension of a delay-Doppler plane, relative to when the first window function is not applied; and
the second window function is configured to improve localization of objects by radar receivers in a Doppler dimension of the delay-Doppler plane, relative to when the second window function is not applied.

54. A radar receiver comprising:
receiver circuitry configured to receive echoes of transmitted radar signals; and
processing circuitry operatively coupled to the receiver circuitry, wherein the processing circuitry and the receiver circuitry are configured to:
receive a composite signal corresponding to a transmitted radar signal, wherein:
the composite signal comprises a plurality (M) of signal streams corresponding to a respective plurality (M) of signal pulses in the transmitted radar signal,
each signal pulse in the transmitted radar signal includes a main pulse and a cyclic extension (CE), and each signal stream includes delayed samples corresponding to a plurality of propagation delays of the corresponding signal pulse;
perform a cyclic correlation of each signal stream with a replica of the main pulse of the corresponding signal pulse, thereby generating a delay-time plane comprising a plurality (M) of correlation streams including samples corresponding to the plurality of propagation delays;
perform a plurality of discrete Fourier transforms (DFTs) on the correlation streams to generate a delay-Doppler plane, wherein the respective DFTs are performed on samples from all correlation streams corresponding to respective propagation delays; and
search the delay-Doppler plane for magnitude peaks corresponding to detected objects.

55. The radar receiver of claim 54, wherein the processing circuitry and the receiver circuitry are configured to perform the cyclic correlation of each signal stream with the replica of the main pulse of the corresponding signal pulse based on the following operations, for each signal stream:
performing a DFT of the signal stream;
computing an element-by-element product between the DFT of the signal stream and a complex conjugate of the replica of the main pulse; and
performing an inverse DFT of the element-by-element product, thereby generating the cyclic correlation of the signal stream.

56. The radar receiver of claim 55, wherein the processing circuitry and the receiver circuitry are configured to perform the cyclic correlation of each signal stream with the replica of the main pulse of the corresponding signal pulse further based on, for each signal stream, applying a first window function to one of the following:
the DFT of the signal stream, or
the element-by-element product between the DFT of the signal stream and the complex conjugate of the replica of the main pulse.

57. The radar receiver of claim 54, wherein the processing circuitry and the receiver circuitry are further configured to apply a second window function to the correlation streams thereby generating windowed correlation streams, wherein:
respective values of the second window function are applied to all samples of respective correlation streams; and
the plurality of DFTs are performed on the windowed correlation streams.

58. A radar transmitter comprising:
transmitter circuitry configured to transmit radar signals; and
processing circuitry operatively coupled to the transmitter circuitry, wherein the processing circuitry and the transmitter circuitry are configured to perform the method of claim 46.
